(19) United States
(12) Patent Application Publication
(10) Pub. No.: US 2011/0026993 A1
(43) Pub. Date: Feb. 3, 2011

(54) POSITIONABLE DOCTOR BLADE HOLDERS INCLUDING AT LEAST ONE INTERNAL PLENUM

(75) Inventors: David Leeman, Worcester, MA (US); Royal Gauvin, Windham, ME (US)

Correspondence Address: GAUTHIER & CONNORS, LLP, 225 FRANKLIN STREET, SUITE 2300, BOSTON, MA, 02110, US

(73) Assignee: KADANT INC., Westford, MA (US)

(21) Appl. No.: 12/854,219

(22) Filed: Aug. 11, 2010

Related U.S. Application Data
(63) Continuation of application No. PCT/US2009/035247, filed on Feb. 26, 2009.
(60) Provisional application No. 61/032,099, filed on Feb. 28, 2008.

(51) Int. Cl. G03G 21/00

(52) U.S. Cl. 399/351

(57) ABSTRACT

A doctor blade holder is disclosed that includes a first member, a second member position adjustment elements, and fluid assisted cleaning elements. The first member includes an elongated edge that is adapted for receiving a doctor blade, and the second member is movably coupled to the first member. The second member is secured to a doctor back. The position adjustment elements are for adjusting the relative position of the first member and the second member. The fluid assisted cleaning elements are for providing pressurized fluid to an area near an elongated edge of the doctor blade. The fluid assisted cleaning elements include at least one plenum within the first member.

### PRIORITY

This application claims priority to U.S. Provisional Patent Application Ser. No. 61/032,099 filed Feb. 28, 2008.

### BACKGROUND OF THE INVENTION

1. Field of the Invention

This invention relates to doctor blade holders, and is concerned in particular with an improved design that facilitates holder sheet shedding, and water or debris removal performance while maintaining desired doctor blade holder performance.

2. Description of the Prior Art

Many roll cleaning and sheet shedding applications on paper machines and other web handling applications involve blade support devices commonly referred to as doctor blade holders. Typically, a doctor blade holder is mounted on a doctorback which is a heavy-duty beam that spans the paper machine width. The rear portion of a doctor blade is received into the holder which supports the blade in a pre-determined position relative to a surface to be cleaned. The holder works in concert with the doctoring assembly to apply the working edge of the blade, found on the blade's front portion, to an adjacent moving surface.

U.S. Pat. No. 6,491,791 discloses a method and apparatus to clean roll surfaces or fabrics used in papermaking machines, wherein a doctoring element (4) includes one or two integral doctor blades (9, 9A) as well as an integral gas chamber (50) that provides pressurized gas, e.g., compressed air, to the outgoing side of a doctoring apparatus having one doctor blade (9), and to the inter-blade area of a doctoring apparatus having two doctor blades (9, 9A). The compressed air is provided to enhance the water or dirt removal capabilities. Each of the disclosed apparatus involves doctor blades that are integral with the structure forming the gas chamber within the doctoring element. The example of a two blade doctoring element, for example, provides that the interblade space forms a closely and tightly delineated pocket into which compressed air may be passed (col. 3, lines 18-20). The high pressure compressed air in an example, escapes under the doctor blades via grooves on the grooved-shell roll being processed (col. 6, lines 59-63). The use of such integral doctor blades requires that the entire doctoring element be replaced whenever the doctor blades become too worn. The doctoring apparatus are also not disclosed to be position adjustable with respect to the roll, and it is not at all clear how such an integral gas chamber may be incorporated in a doctoring apparatus that provides adjustable position accuracy with respect to a roll as well as flexibility in doctoring a roll along an elongated length of the doctor blade.

U.S. Pat. No. 6,139,638 discloses a doctor blade holder apparatus that includes a planar upper holding member that is pivotally mounted to a tray such that the position of the upper holding member (34) with respect to the tray (26) may be adjusted by unloading and loading tubes (30, 32). The upper holding member (34) also includes a plurality of distribution passages (60) that are coupled respectively off of the upper holding member (34) via a plurality of branch conduits (62) to a common header (64). The apparatus requires therefore, that the plurality of branch conduits (62) be provided along the elongated length of the holding member (34), which adds to manufacturing costs and complexity. Moreover, the pressurized fluid must maintain sufficiently equalized pressure as it travels through the separate conduits (62) as the fluid is directed toward the roll along the elongated length of the doctor blade.

There remains a need, therefore, for a doctor blade holder system that facilitates consistent debris removal without limiting the flexibility of the doctor blade holder system or the effectiveness of the doctoring process.

### SUMMARY OF THE INVENTION

An object of the present invention is to provide a doctor blade holder specifically designed to apply pressurized fluid to assist in the detachment of a paper web from a roll surface and convey the web away from the roll.

Another object is to integrate the one or more fluid delivery systems into the holder body in a manner that serves the design intent of a well managed web exit from its detaching point.

Another object is to integrate within the same holder body additional pressurized fluid delivery means and directing said fluid to the area near the blade-roll contact line in order to remove debris that is known to accumulate there.

Another object is to provide within the holder body fluid jets designed to evacuate the water or debris dislodged from the cleaned surface.

Another object is to provide doctor blade holders that provides for effective fluid delivery onto the doctor blade yet also facilitates the replacement of worn doctor blades.

Another object is to provide within the holder design a two-tube blade loading and unloading system familiar to paper machine operators and easily integrated with pre-existing equipment.

Another object is to incorporate groups of one or more holder components into formed pieces via extrusion processes thereby reducing assembly part counts and associated labor, as compared to the multiple part assembly processes of certain prior art holders.

Another object is to provide additional cross-machine flexibility by sectioning the rotating portion of a full-length holder into a multiplicity of shorter cross-machine pieces that may be assembled individually and/or together with the doctor base piece to form a segmented full-length holder assembly.

The invention provides a doctor blade holder that includes a first member, a second member position adjustment elements, and fluid assisted cleaning elements. In accordance with an embodiment, the first member includes an elongated edge that is adapted for receiving a doctor blade, and the second member is movably coupled to the first member. The second member is secured to a doctor back. The position adjustment elements are for adjusting the relative position of the first member and the second member. The fluid assisted cleaning elements are for providing pressurized fluid to an area near an elongated edge of the doctor blade. The fluid assisted cleaning elements include at least one plenum within the first member.

In accordance with another embodiment, the first member includes an elongated edge that is adapted for receiving a doctor blade, and the second member is movably coupled to the first member by pivotal coupling structure that includes at least a portion thereof that is integrally formed with the first member. The second member is secured to a doctor back. The position adjustment elements are for adjusting the relative position of the first member and the second member. The position adjustment means includes a portion that is secured to the first member by mounting structure that is integrally formed with the first member. The fluid assisted cleaning elements are for providing a first pressurized fluid to a leading edge side of an elongated edge of the doctor blade. The fluid assisted cleaning elements include a first plenum within the first member.

In accordance with a further embodiment, the first member includes an elongated edge that is adapted for receiving a doctor blade. The second member is movably coupled to the first member and is also secured to a doctor back. The position adjustment elements are for adjusting the relative position of the first member and the second member. The position adjustment elements include at least one fluid expandable reservoir that causes the relative position of the first and second members to be changed when fluid is introduced into the fluid expandable reservoir. The fluid assisted cleaning elements are for directing a first pressurized fluid onto a leading edge side of an elongated edge of the doctor blade. The fluid assisted cleaning elements include a first plenum within the first member.

### BRIEF DESCRIPTION OF THE DRAWINGS

The following description may be further understood with reference to the accompanying drawings in which:

FIG. 1 is an illustrative diagrammatic side view of a doctor blade holder in accordance with an embodiment of the present invention attached to a doctorback;

FIG. 2 is an illustrative diagrammatic enlarged side view of the doctor blade holder of FIG. 1;

FIG. 3 is an illustrative diagrammatic isometric view from above of a portion of the doctor blade holder of FIG. 1;

FIG. 4 is an illustrative diagrammatic cross-sectional view of the doctor blade holder of FIG. 3 taken along line 4-4 thereof;

FIG. 5 is an illustrative diagrammatic exploded isometric view from below of the doctor blade holder of FIG. 1;

FIG. 6 is an illustrative diagrammatic sectional view of an enlarged portion of the doctor blade holder of FIG. 5;

FIG. 7 is an illustrative diagrammatic isometric view from above of a doctor blade holder in accordance with an embodiment of the invention shown without the doctor blade and cover elements;

FIG. 8 is an illustrative diagrammatic isometric view from above of the doctor blade holder of FIG. 7 including the doctor blade and a plurality of cover elements.

FIG. 9 is an illustrative diagrammatic cross-sectional view of a doctor blade holder of another embodiment of the invention similar to the view shown in FIG. 4 of the first embodiment; and

FIG. 10 is an illustrative diagrammatic sectional view of an enlarged portion of the doctor blade holder of FIG. 9;

The drawings are shown for illustrative purposes only.

### DETAILED DESCRIPTION

The present invention incorporates one or more fluid supply plenums for piping fluid into the body of the holder. The supply piping system distributes pressurized fluid to one or more nozzles arrayed along the holder in an elongated direction. The pressurized fluids may be used to assist the doctor blade holder in the detachment of a paper web from a roll surface; to shower the doctor blade generally, or particularly in the area near the blade-to-surface contact line; or to dislodge water or debris from process surfaces such as grooved or drilled rolls.

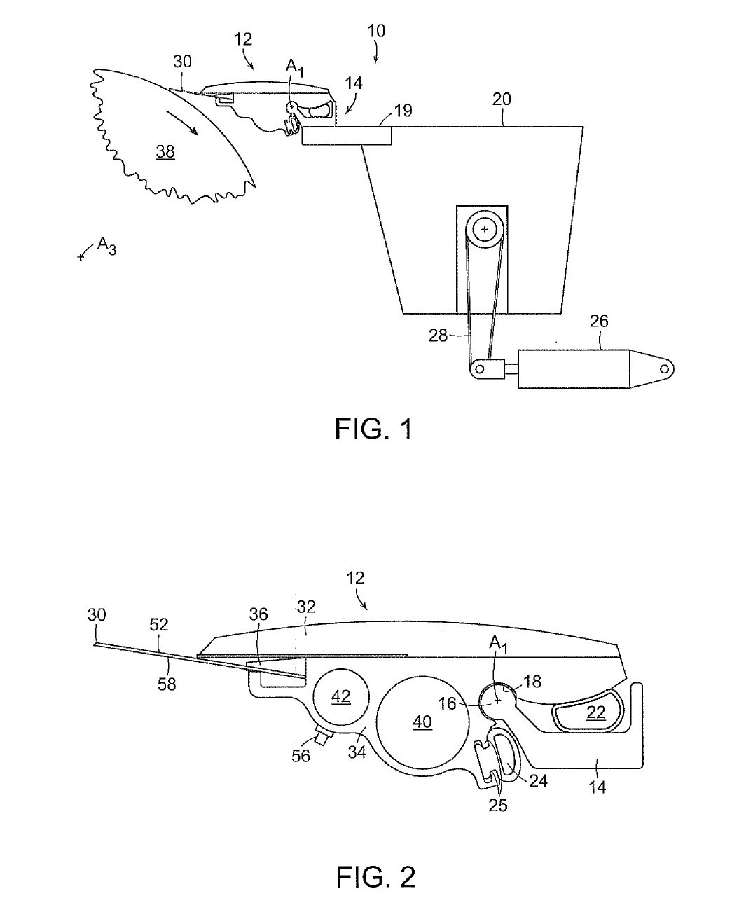

As shown in FIGS. 1 and 2, a doctoring apparatus including a doctor blade holder 10 in accordance with an embodiment of the invention includes a first member 12 that is pivotally mounted on a second member 14 such that limited pivotal rotation is permitted with respect to an axis A₁. As shown in FIG. 2, the pivotal rotation is provided by an integrally formed pivotal coupling structure such as continuous rounded male portion 16 on the second member that is received within an integrally formed pivotal coupling structure such as continuous socket portion 18 on the first member. In other embodiments, an integrally formed continuous male portion may be provided on the first member, with an integrally formed continuous socket portion being provided on the second member. The first member 12 receives a doctor blade 30 along an elongated edge of the first member 12, and the second member 14 is attached to a beam 19 that is attached to a doctor back 20. The rotational position of the first member with respect to the second member is provided by inflatable loading and unloading reservoirs such as tubes 22, 24. Pivotal rotation of the doctor back 20 is provided by a piston 26 that is coupled to a crank arm 28 to provide rotation of the doctor back 20 with respect to an axis A₂ that is parallel to the axis A₁.

As also shown in FIG. 2, the first member 12 includes a cap 32 and a body 34, and the doctor blade 30 is received between a portion of the cap 32 and the body 34, and may be held in place by an optional spring element 36. The doctor blade 30 may be readily replaced as desired, for example, when the doctor blade becomes worn, without replacing the entire doctoring apparatus. As a roll 38 rotates about an axis A₃, the doctor blade 30 is applied to the roll. Plenums 40, 42 within the body 34 of the first member 12 are defined by walls that are integrally formed with the first member, and contain pressurized fluid, such as air or water, that are applied to the doctor blade 30 during processing as discussed in more detail below. Each plenum may provide the same fluid or may provide different fluids. The cap 32 and body 34 are joined together using fasteners 44 that are received within apertures 46 in the cap 32 and are secured to the body 34.

The first member 12 and second member 14 are formed preferably by extrusion or pultrusion, from metal, such as stainless steel alloys such as 300 series, or aluminum alloys such as series 6000. Aluminum alloys are preferably treated with one or more protective coatings well known to those skilled in the art. The cap 21 may alternatively be comprised of a multiplicity of short pieces, extruded or cast from above mentioned alloys, the multiple cap pieces being attached to the rotator 22 is the same manner as for the single, elongated cap. In further embodiments, the members 12, 14 may be formed of high temperature resistant polymeric materials or resins, and may include filler material such as fiberglass, ceramic and/or metallic materials.

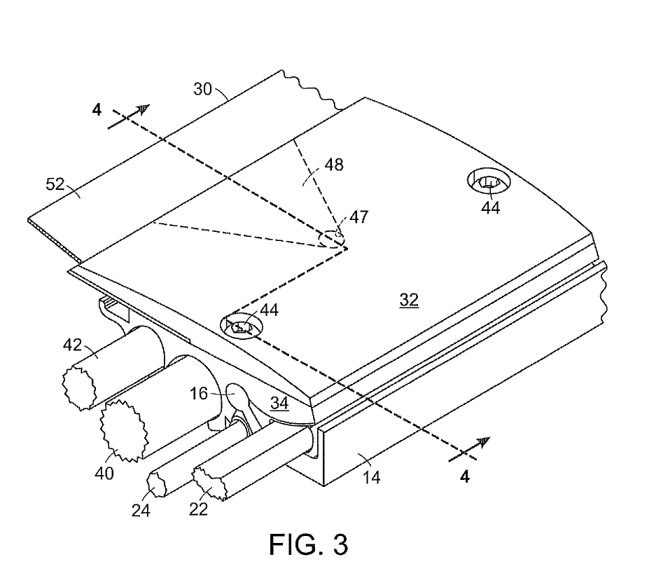

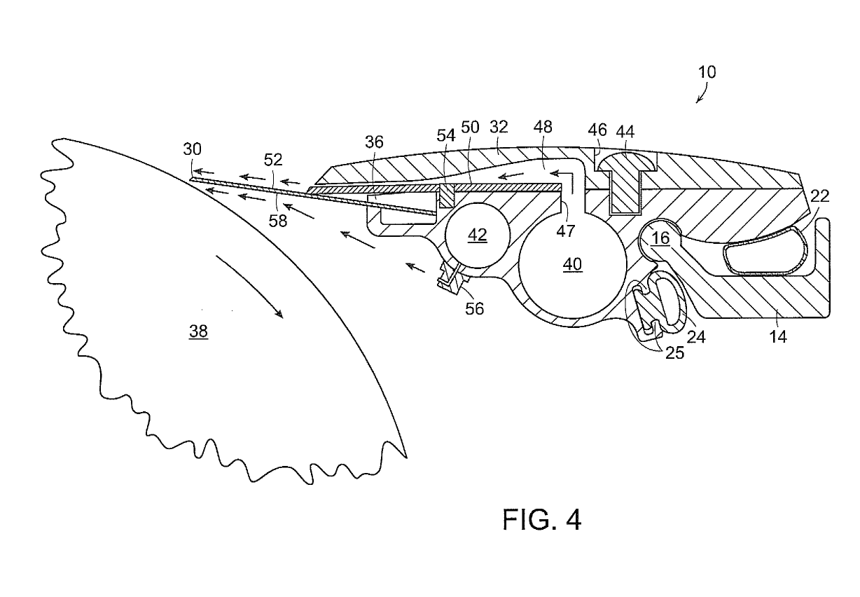

With further reference to FIGS. 3 and 4, air is provided to the inflatable loading and unloading tubes 22, 24 via conduits that may be provided at one or both ends of each of the tubes 22, 24. At least one of the tubes (e.g., 24 as shown in FIGS. 2, 4 and 5) may be mounted to the first member 12 by mounting structure 25 that is integrally formed with the first member 12. Pressurized fluid, such as compressed air, is provided to the doctoring apparatus via a conduit coupled to the plenum 40, and another fluid, such as water, is provided under pressure within the plenum 42 via a conduit as well. Each of the plenums 40, 42 may be coupled to such conduits at one or both ends of the doctoring apparatus.

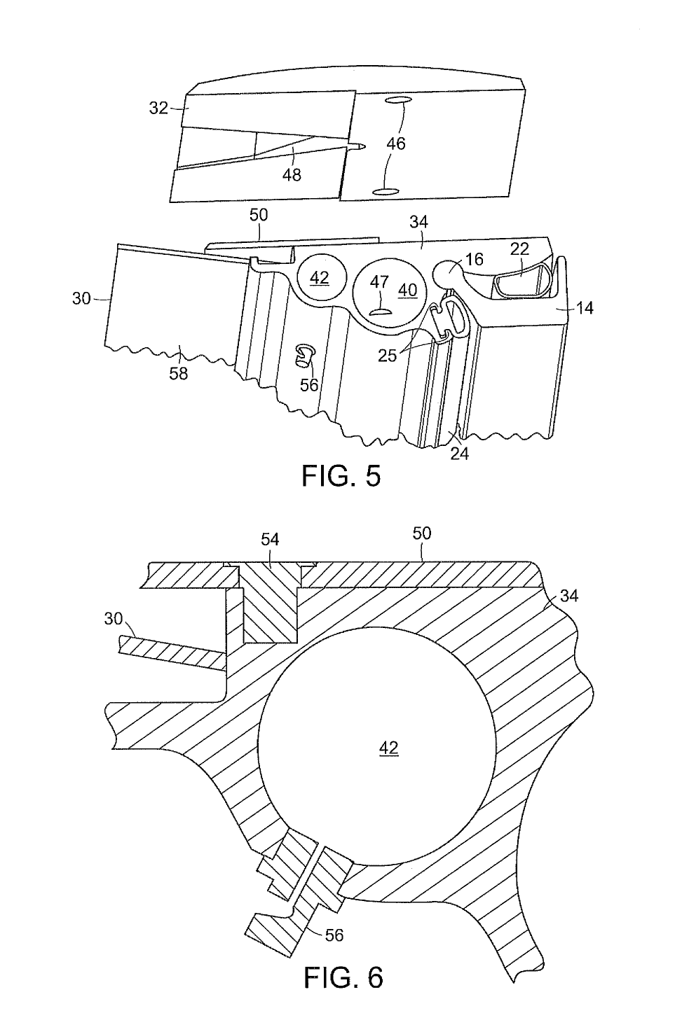

As shown in FIG. 5, the compressed air from within the plenum 40 travels out of the plenum 40 and toward the blade 30 via ports 47 that lead to a plurality of passages 48 formed between the cap 32 and a guide plate 50 on the body 34. The guide plate 50 directs the compressed air onto the leading edge side 52 of the blade 30 as the roll 38 rotates. A flush fastener 54 is employed to secure the guide plate 50 to the body 34.

As shown in FIG. 6, the fluid under pressure from the plenum 42 (such as water or air) travels out of the plenum 42 and toward the blade 30 via a flood fan nozzle 56, which as shown in FIG. 4, directs the water stream toward the trailing edge side 58 of the blade 30 as the roll 38 rotates.

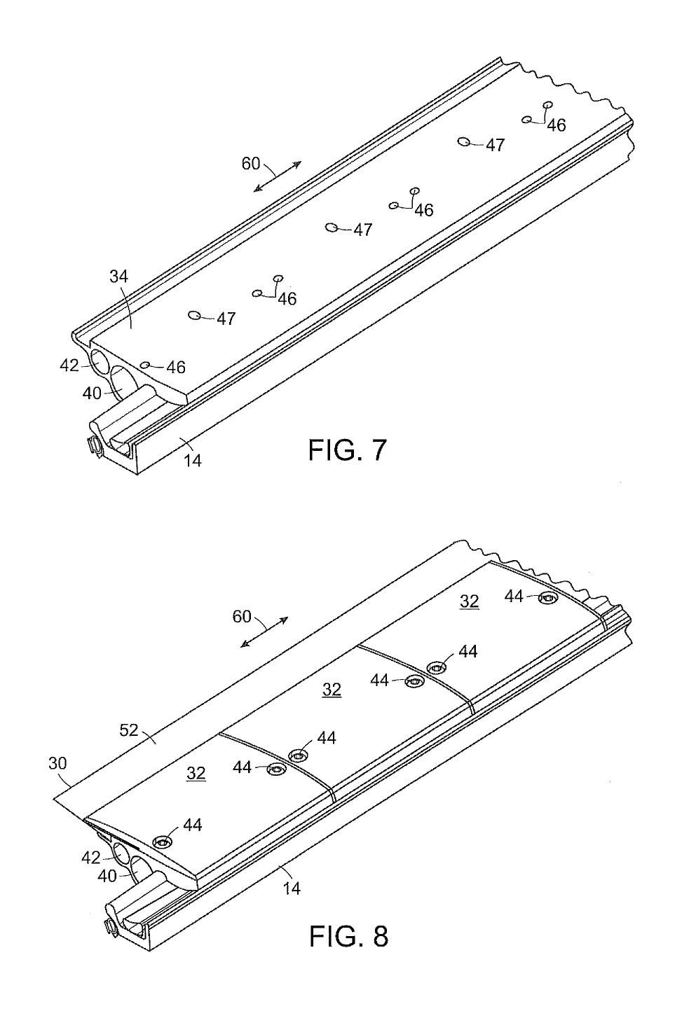

As shown in FIGS. 7 and 8, multiple caps 32 are provided along the body 34, in an elongated direction as shown at 60, and each cap 32 includes a passage that aligns with a port 47 of the continuous plenum 40 in the body 34. Each cap 32 is secured to the body 34 by fasteners 44 within apertures 46 of the caps 32.

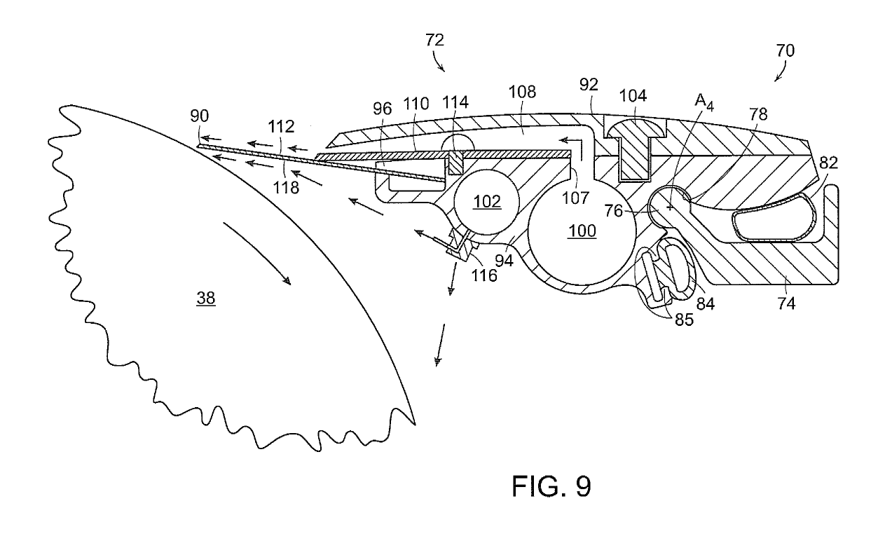

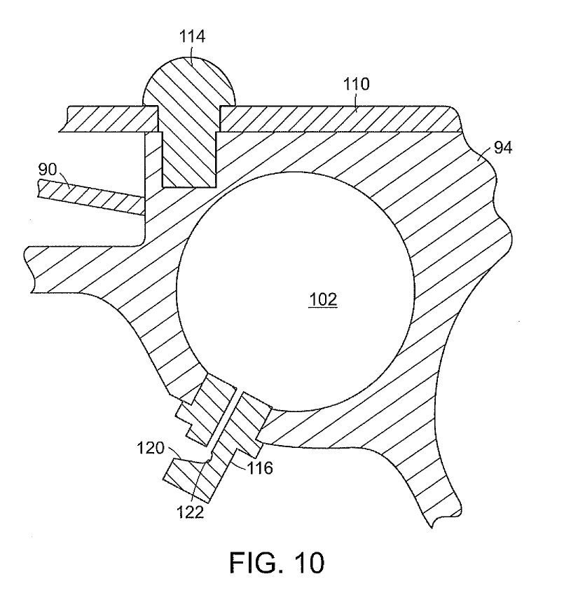

FIGS. 9 and 10 show a doctor blade holder 70 in accordance with another embodiment of the invention that includes a first member 72 that is pivotally mounted on a second member 74 such that limited pivotal rotation is permitted with respect to an axis A₄. The pivotal rotation is provided by an integrally formed pivotal coupling structure such as a continuous rounded male portion 76 on second member that is received within an integrally formed pivotal coupling structure such as a continuous socket portion 78 on the first member. In other embodiments, an integrally formed continuous male portion may be provided on the first member, with an integrally formed continuous socket portion being provided on the second member. The first member 72 receives a doctor blade 90 along an elongated edge of the first member 72. The rotational position of the first member with respect to the second member is provided by inflatable loading and unloading reservoirs such as tubes 82, 84. The second member is attached to a doctor back as discussed above with reference to FIG. 1, and pivotal rotation of a doctor back is provided by a piston that is coupled to a crank arm to provide rotation of the doctor back.

The first member 72 includes a cap 92 and a body 94, and the doctor blade 90 is received between a portion of the cap 92 and the body 94, and may be held in place by an optional spring element 96. As the roll 38 rotates, the doctor blade 90 is applied to the roll. Plenums 100, 102 within the body 94 of the first member 72 are defined by walls that are integrally formed with the first member 72, and contain pressurized fluid, such as air or water, that are applied to the doctor blade 90 during processing. The cap 92 and body 94 are joined together using fasteners 104. The first and second members 72, 74 are formed as discussed above with reference to FIGS. 1-8.

Air is provided to the inflatable loading and unloading tubes 82, 84 via conduits as discussed above. At least one of the tubes (e.g., 84 as shown in FIG. 9) may be mounted to the first member 72 by mounting structure 85 that is integrally formed with the first member 72. Pressurized fluid, such as compressed air, is provided to the doctoring apparatus via a conduit coupled to the plenum 100, and another fluid, such as water, is provided under pressure within the plenum 102 via a conduit as well as also discussed above. Each of the tubes 82, 84 and the plenums 100, 102 may be coupled to such conduits at one or both ends of the doctoring apparatus.

The compressed air from within the plenum 100 travels out of the plenum 100 and toward the blade 90 via ports 107 that lead to either a plurality of passages (such as shown at 48 in FIG. 5) or a single elongated passage 108 formed between the cap 92 and a guide plate 110 on the body 94. The guide plate 110 directs the compressed air onto the leading edge side 112 of the blade 90 as the roll 38 rotates. A combined fastener and flow restrictor 114 is employed to secure the guide plate 11 to the body 94, as well as to controllably restrict the flow of compressed gas within the passage 108.

The water under pressure from the plenum 102 travels out of the plenum 102 and toward the blade 90 via a bidirectional nozzle 116 that via a first opening 120 directs a first water stream toward the trailing edge side 118 of the blade 90 as the roll 38 rotates, and via a second opening 122 directs a second water stream onto the roll 38. The first and second water streams may be, for example, 90-120 degrees from one another.

Doctoring assemblies including doctor blade holders of various embodiments of the invention permit the doctor blade to provide the requisite structural and mechanical properties for processing the roll, while also permitting a first fluid to be directed toward a leading edge side of the blade, and permitting a second fluid to be directed toward a trailing edge side of the blade during processing or the roll.

Those skilled in the art will appreciate that numerous modifications and variations may be made to the above disclosed embodiments without departing from the spirit and scope of the invention.

What is claimed is:

1. A doctor blade holder comprising:
a first member including an elongated edge that is adapted for receiving a doctor blade;
a second member that is movably coupled to the first member, said second member being secured to a doctor back;
position adjustment means for adjusting the relative position of the first member and the second member; and
fluid assisted cleaning means for providing pressurized fluid to an area near an elongated edge of the doctor blade, said fluid assisted cleaning means including at least one plenum within the first member.

2. The doctor blade holder as claimed in claim 1, wherein said fluid assisted cleaning means includes at least two plenums within the first member.

3. The doctor blade holder as claimed in claim 2, wherein one of said at least two plenums is coupled to a plurality of first delivery passages that are directed to a leading edge of the doctor blade.

4. The doctor blade holder as claimed in claim 3, wherein a second of said at least two plenums is coupled to a plurality of second delivery passages that are directed to a trailing edge of the doctor blade.

5. The doctor blade holder as claimed in claim 4, wherein said first of said at least two plenums includes air under positive pressure, and wherein said second of said at least two plenums includes water under positive pressure.

6. The doctor blade holder as claimed in claim 2, wherein said at least two plenums each include the same pressurized fluid.

7. The doctor blade holder as claimed in claim 1, wherein said position adjustment means further includes a fluid expandable reservoir that is secured to the first member by an integrally formed mounting structure.

8. The doctor blade holder as claimed in claim 1, wherein said position adjustment means includes at least one fluid expandable reservoir is mounted on the first member and causes the relative position of the first and second members to be changed when fluid is introduced into the fluid expandable reservoir.

9. The doctor blade holder as claimed in claim 8, wherein said at least one fluid expandable reservoir is mounted on the first member by mounting structure that is integrally formed with the first member.

10. The doctor blade holder as claimed in claim 1, wherein said fluid assisted cleaning means further includes a plurality of passage openings in a cover portion of the first member.

11. The doctor blade holder as claimed in claim 10, wherein said cover portion includes a plurality of cover structures adjacent one another along a direction that is parallel with the elongated edge of the doctor blade.

12. A doctor blade holder comprising:
a first member including an elongated edge that is adapted for receiving a doctor blade;
a second member that is movably coupled to the first member by pivotal coupling structure that includes at least a portion thereof that is integrally formed with the first member, said second member being secured to a doctor back;
position adjustment means for adjusting the relative position of the first member and the second member, said position adjustment means including a portion that is secured to the first member by mounting structure that is integrally formed with the first member; and
fluid assisted cleaning means for providing a first pressurized fluid to a leading edge side of an elongated edge of the doctor blade, said fluid assisted cleaning means including a first plenum within the first member.

13. The doctor blade holder as claimed in claim 12, wherein the fluid assisted cleaning means further includes a second plenum within the first member for providing a second pressurized fluid to a trailing edge side of the elongated edge of the doctor blade.

14. The doctor blade holder as claimed in claim 13, wherein the first pressurized fluid is air, and the second pressurized fluid is water.

15. The doctor blade holder as claimed in claim 12, wherein said position adjustment means includes at least one fluid expandable reservoir within the first member.

16. The doctor blade holder as claimed in claim 12, wherein said fluid assisted cleaning means further includes a plurality of passage openings in a cover portion of the first member.

17. The doctor blade holder as claimed in claim 12, wherein said cover portion includes a plurality of cover structures adjacent one another along a direction that is parallel with the elongated edge of the doctor blade.

18. A doctor blade holder comprising:
a first member including an elongated edge that is adapted for receiving a doctor blade;
a second member that is movably coupled to the first member, said second member being secured to a doctor back;
position adjustment means for adjusting the relative position of the first member and the second member, said position adjustment means including at least one fluid expandable reservoir that causes the relative position of the first and second members to be changed when fluid is introduced into the fluid expandable reservoir; and
fluid assisted cleaning means for directing a first pressurized fluid onto a leading edge side of an elongated edge of the doctor blade, said fluid assisted cleaning means including a first plenum within the first member.

19. The doctor blade holder as claimed in claim 18, wherein said fluid assisted cleaning means further includes a plurality of passage openings in a cover portion of the first member, and wherein said cover portion includes a plurality of independent cover structures adjacent one another along a direction that is parallel with the elongated edge of the doctor blade.

20. The doctor blade holder as claimed in claim 18, wherein the fluid assisted cleaning means further includes a second plenum within the first member for providing a second pressurized fluid to a trailing edge side of the elongated edge of the doctor blade.
